(19) United States
(12) Patent Application Publication
(10) Pub. No.: US 2023/0202736 A1
(43) Pub. Date: Jun. 29, 2023

(54) FOOD CONTAINER FOR PRESERVING FRESHNESS OF FOOD ITEMS

(71) Applicant: KING'S FLAIR INNOVATIVE MARKETING LIMITED, Hong Kong (HK)

(72) Inventor: Siu Wah WONG, Hong Kong (HK)

(21) Appl. No.: 18/182,170

(22) Filed: Mar. 10, 2023

Related U.S. Application Data
(63) Continuation-in-part of application No. 16/683,697, filed on Nov. 14, 2019.
(60) Provisional application No. 62/767,845, filed on Nov. 15, 2018.

(51) Int. Cl. B65D 81/26; B65D 51/24; A23B 7/148; A23L 3/3436; B01D 53/02; B01J 20/18; B01J 20/10; B01J 20/20; B01J 20/34; B01J 20/28

(52) U.S. Cl. CPC B65D 81/267; A23B 7/148; A23L 3/3436; B01D 53/02; B01J 20/20; B01J 20/103; B01J 20/186; B01J 20/2805; B01J 20/3408; B01J 20/3416; B01J 20/3441; B01J 20/3483; B01J 20/28038; B65D 51/244; B65D 81/268; B01D 2253/102; B01D 2253/108; B01D 2253/3425; B01D 2257/80; B01D 2257/104; B01D 2257/7022; B01D 2259/4541; B01D 2259/40088

(57) ABSTRACT

The invention discloses a food container for preserving freshness of food, comprising a container body having a cavity adapted for containing food items; a lid detachably secured on the container body to close the cavity of the container; and one or more food preserving elements capable of absorbing food spoiling gas to preserve freshness of the food items. The one or more food preserving elements are disposed inside the cavity and/or into a material of the food container to preserve the food items for an extended period of time and remove odors.

### CROSS REFERENCE TO RELATED PATENT APPLICATION

This continuation-in-part application claims priority to and benefit of U.S. Provisional Pat. Application No. 62/767,845 filed on Nov. 15, 2018, and pending U.S. Utility Pat. Application No. 16/683,697 filed on Nov. 14, 2019.

### FIELD OF THE INVENTION

The present invention relates generally to a food container that can be used for preserving freshness of food, and in particular a food container having food preserving elements capable of absorbing food spoiling gas to preserve freshness of the food items for an extended period of time.

### BACKGROUND OF THE INVENTION

With increasing varieties and categories of food and beverages, a food container adapted for preserving freshness of food and ready-to-eat have been receiving considerable attention as consumers become more conscious of health, convenience and quality of food. To preserve the freshness food during storage, it is desirable to absorb food spoiling gas, including ethylene, moisture and unpleasant smell.

Climacteric fruits such as apples, bananas, melons, mango etc. continue to ripen after they are picked from trees under the effect of ripening agents. Such fruits are usually picked prior to full ripening for enabling extended shipping and distribution period. The ripening agents, typically ethylene, can be provided on demand to accelerate the ripening process. However, ethylene is released simultaneously and continuously from climacteric fruits for self-ripening of the fruits. When packaging climacteric fruits in closed containers, ethylene accumulates around the fruits and causes undesirable ripening, which may reduce the shelf-time and storage period of the fruits. In order to control the ripening process, it is provided herein a series of designs of food containers for preventing self-ripening of fruit in order to keep the fruit fresh for a longer period of time.

Many foods contain appreciable amounts of moisture capable of encouraging growth of bacteria or other microorganisms, which can reduce shelf life and quality of the packaged food. Therefore, absorbing moisture exuded from meat, poultry, seafood, and fruit, purposefully improves the safety, shelf life, and aesthetics of the food stored in a confined area.

Cooked or non-cooked foods such as meat, poultry, fish, and other seafood may have a particular odor, especially if stored and/or frozen for a while, and not fresh. Other foods, especially spices, such as garlic, onion, curry, can leave a difficulty to remove, detectable and undesirable smell during storage.

It is desirable to have a food container that is effective in removing the undesirable food spoiling gas, and preferably, the gas removal performance can be recovered or retained.

### SUMMARY OF THE INVENTION

The present invention has a principle object of providing a food container for preserving freshness of food, which comprises food preserving elements capable of absorbing food spoiling gas to preserve freshness of the food items.

The object of the present invention is attained by the provision of a food container for preserving freshness of food, the food container comprises: a container body having a cavity adapted for containing food items, a lid detachably secured on the container body to close the cavity of the container, and one or more food preserving elements capable of absorbing food spoiling gas to preserve freshness of the food items, wherein the one or more food preserving elements are releasably disposed inside the cavity and/or into a material of the food container.

In one embodiment of the present invention, the food preserving element is provided in a form of a membrane comprising at least one gas absorbent capable of absorbing the food spoiling gas, the membrane is configured to releasably attached onto a lower surface of the lid or an inner surface of the cavity of the container.

Particularly, the membrane comprises a membrane substrate and the at least one gas absorbent disposed on or into the membrane substrate. More particularly, the membrane substrate comprises a nanoporous sheet-like material, preferably a nanoporous sheet-like fabric, and more preferably an activated carbon cloth, and the gas absorbent is applied on and/or into the sheet-like material. Preferably, the gas absorbent is applied by an adhesive resin to be dispersed or coated on the sheet-like material. More preferably, the adhesive resin is a silicone binder.

Also particularly, the membrane is removably encapsulated in a casing comprising a first porous casing portion and a second porous casing portion removably engageable with the first casing portion to form the casing. Preferably, the casing further comprises one or more attaching elements for releasably attaching to the lower surface of the lid or the inner surface of the cavity of the container. In some embodiments, the attaching element is selected from the group consisting of suction cup, self-adhesive and magnet, hook and bar fastener, and hook and loop velcro.

Alternatively, the food preserving element in the one embodiment is provided in a form of a honeycomb filter or a teabag pouch with at least one gas absorbent capable of absorbing the food spoiling gas embedded or encased therein.

In a further embodiment of the present invention, the food preserving element is selected from at least one gas absorbent capable of absorbing the food spoiling gas, the gas absorbent being added into a plastic material useful for making the food container. Particularly, the gas absorbent is added in a ratio of about 0.5-10%, preferably about 1-5%, by weight of the plastic material. Preferably, the plastic material is thermoplastics selected from the group consisting of polypropylene resin, and monomers of di-methylterephthalate (DMT), 1,4-cyclohexanedimethanol (CHDM), and 2,2,4,4-tetramethyl-1,3-cyclobutanediol (TMCD). Advantageously, the food container is subject to a heating treatment for regeneration of the food container.

According to the invention, the food spoiling gas is at least one selected from the group consisting of ethylene, moisture, oxygen and any combination thereof. The gas absorbent includes zeolite based substance including potassium-treated zeolite, activated carbon, silica including potassium permanganated silica, or any mixture thereof

To have a better understanding of the invention reference is made to the following detailed description of the invention and embodiments thereof in conjunction with the accompanying drawings.

### BRIEF DESCRIPTION OF THE DRAWING

FIG. 1 is a schematic view of a food preserving element constructed consistent with a first embodiment of the food container of the present invention.

FIG. 2A is a schematic perspective view showing the food preserving element as shown in FIG. 1.

FIG. 2B is an exploded perspective view of the food preserving element as shown in FIG. 2A by incorporating a membrane.

FIG. 2C is an exploded perspective view of the food preserving element as shown in FIG. 2A by incorporating a honeycomb filter.

FIG. 2D is an exploded perspective view of the food preserving element as shown in FIG. 2A by incorporating a teabag pouch.

FIG. 3 is a perspective view of a variation of the food preserving element of FIG. 2A.

FIG. 4A is a cross-sectional view of a food preserving element constructed consistent with a second embodiment of the food container of the present invention.

FIG. 4B is a cross-sectional view of a food preserving element constructed consistent with a third embodiment of the food container of the present invention.

In the various figures of the drawings, like reference numbers are used to designate like parts.

### DETAILED DESCRIPTION OF THE INVENTION

While this invention is illustrated and described in preferred embodiments, the food container comprising food preserving element of the present invention may be produced in many different configurations, sizes, forms and materials, and may be retained to absorb food spoiling gas to preserve freshness of the food items in various manners.

The present invention relates to a food container comprising one or more food preserving elements configured to have the capability of absorbing food spoiling gas to preserve freshness of the food items.

According to the invention, the food preserving elements may be disposed inside the cavity of the food container by releasably attaching onto a lower surface of the lid or an inner surface of the cavity of the food container. The food preserving elements may also be removably encapsulated in a porous casing releasably attaching to the lower surface of the lid or the inner surface of the cavity of the food container.

The food preserving element comprises gas absorbent capable of absorbing ethylene and other food spoiling gas. The gas absorbent for ethylene absorption is called as ethylene absorbent or ethylene scavenger. Ethylene may be physically absorbed by the gas absorbents, adsorbed on the gas absorbents, may be catalyzed by the gas absorbents to react with oxygen or water vapor, or may react with the gas absorbents so as to be consumed and removed from the environment. Exemplary ethylene absorbents include potassium permanganate embedded in silica gel, cation exchanged zeolite as a gas absorbent, and activated carbon with palladium chloride as a catalyst.

The food preserving element may further contain gas absorbent capable of absorbing moisture from the surrounding environment, so as to facilitate control of the humidity level of the food container. From the perspective of moisture absorption, common desiccant materials are suitable as the gas absorbent of the present invention, such as silica gel, calcium oxide, sodium sulfate, calcium chloride, molecular sieve, etc.

Without subject to be bound by theory, besides ethylene, the food spoiling gas may be selected from other chemical substances capable of ripening the food, include but not limited to acetylene, abscisic acid, ethephon, carbon dioxide, oxygen, water, etc. The gas absorbent of the present invention removes or reduces the amount of above ripening agents released by the food.

In some cases, the gas absorbent that is able to absorb both ethylene and other ripening agents and moisture may be selected for incorporation into the food preserving element according to the invention. In some cases, both the ethylene absorbent and the further gas absorbent capable of absorbing other ripening agents and moisture may be selected for incorporation into the food preserving element according to the invention.

The gas absorbent can be incorporated with the food preserving element by various technologies. For example, the gas absorbent can be coated onto the food preserving element; the gas absorbent can be sandwiched by two sheets of food preserving element; the gas absorbent can be blended into the raw materials which made up of the food preserving element.

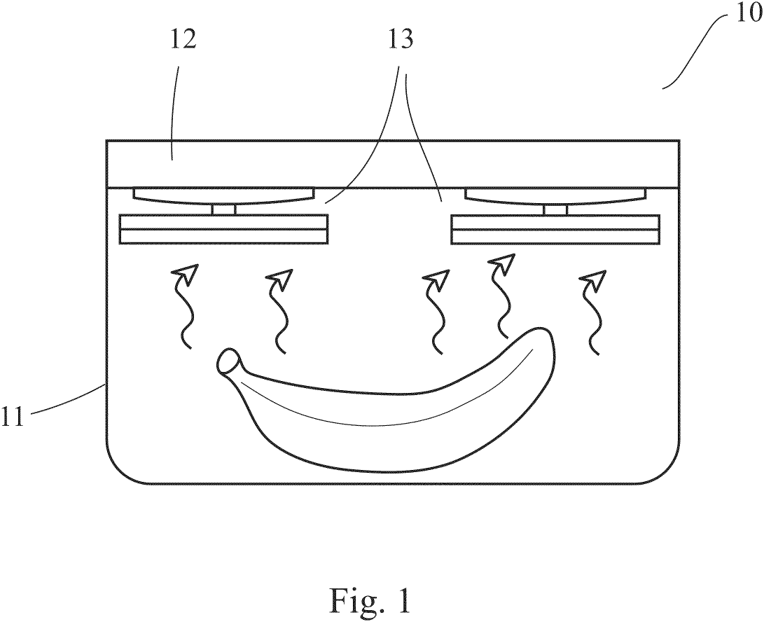

Referring now to the drawings, FIG. 1 illustrates a schematic view of an interior of a food container 10 constructed according to a first embodiment of the present invention. The food container 10 comprises a container body 11 having a cavity adapted for containing food items, e.g. bananas in the embodiment, and a lid 12 detachably secured on the container body to close the cavity of the food container containing the bananas. The food container further comprises a food preserving device 13 for absorbing the food spoiling gases, and the food preserving device 13 is releasably attached to the lower surface of the lid.

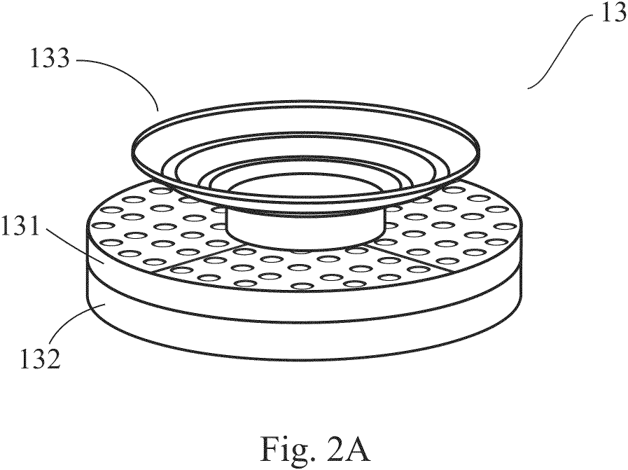

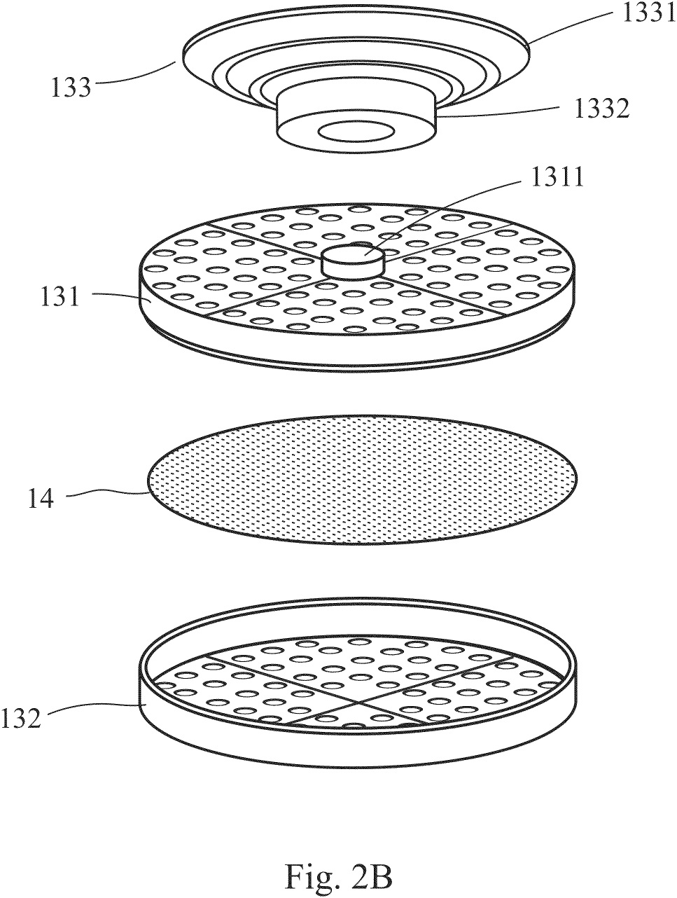

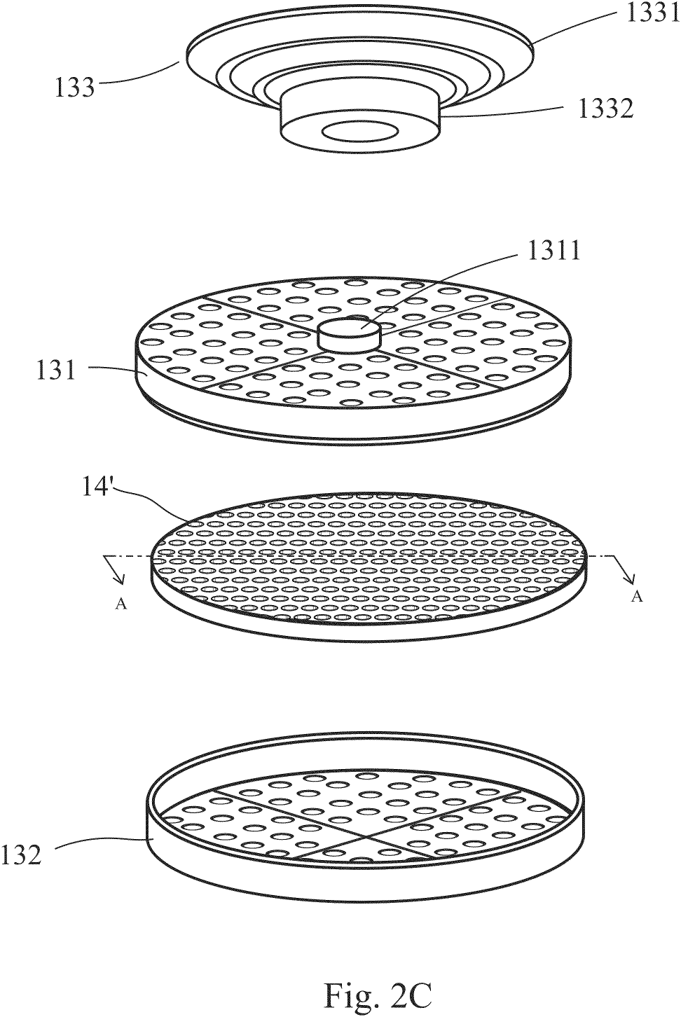

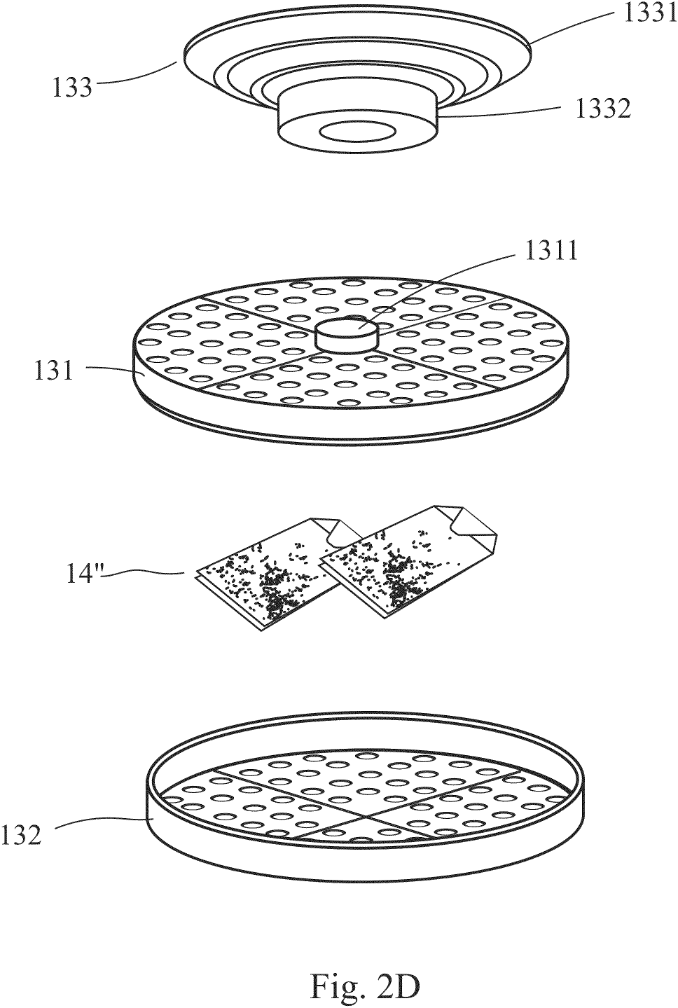

As illustrated in FIGS. 2A and 2B, the food preserving device 13 comprises a membrane 14, a casing for encapsulating the membrane 14, and attaching means configured as a suction cup 133. The casing consists of a first porous casing portion 131, and a second porous casing portion 132 removably engageable with the first casing portion 131 to form a receiving chamber for fully accommodating the membrane 14.

The suction cup 133 comprises an upper cup portion 1331 and a lower coupling portion 1332. The upper cup portion 1331, which is pressed toward the lid, creates negative pressure of air between the upper cup portion and the lower surface of the lid 12 for releasably attaching the food preserving device 13 onto the lower surface of the lid 12. The lower coupling portion 1332 is coupled to a stub 1311 extending from a top of the first casing portion 131 by way of a method well known in the art, for example, threaded connection, snap-fit, and prese-fit.

It would be appreciated that the attaching elements in other forms, including but not limited to, self-adhesive and magnet, hook and bar fastener, and hook and loop Velcro, can be used to attach the food preserving device 13 onto the lower surface of the lid 12. Also it is appreciated that the food preserving device 13 may be attached to the inner surface of the cavity of the food container using the attaching element, for example, the inner surface of one or more side walls of the cavity.

The membrane 14 is capable of absorbing food spoiling gas to preserve freshness of the food items, comprising a membrane substrate and at least one gas absorbent capable of absorbing the food spoiling gas and applied on the substrate.

The gas absorbent according to the present invention includes zeolite based substance, including but not limited to potassium-treated zeolite, silica including but not limited potassium permanganated silica, or any mixture thereof.

The membrane substrate refers to a microporous or nanoporous, preferably nanoporous, sheet-like material, and may be selected from a nanoporous flat sheet-like fabric, an activated carbon cloth, tissue paper, corrugated paper, textile, nonwoven fabric, plastic film, plastic foam, foil or any suitable sheets. The activated carbon cloth refers to a cloth having microporous or nanoporous structure in woven or knitted format loaded with activated carbon known in the art. The tissue paper refers to thin and soft tissue-like materials which are not limited to conventional paper made of wood pulps. Thickness of the membrane substrate are not specifically limited, provided that a sufficient amount of the gas absorbent can be carried by the substrate.

The gas absorbent is applied on and/or into the substrate by an adhesive resin to be dispersed on the substrate, or in the form of a coating on the substrate. Preferably, the adhesive resin is silicone binder. For instance, the membrane is formed by a membrane substrate of carbon fiber or activated carbon cloth on which the gas absorbent is deposited as a coating layer by the silicone binder. The activated carbon cloth is particularly preferable because the cloth per se is already loaded with activated carbon for rapid and effective absorption to remove odors, in addition to its significant specific surface area due to microporous or nanoporous structure.

Advantageously, the membrane 14 further comprises particles of activated carbon deposited on the membrane substrate to absorb moisture, oxygen and remove other odors. With the combination of the activated carbon particles and other gas absorbents for absorption of the food spoiling gas, the membrane 14 allows for absorption of moisture, oxygen, odors as well as ethylene and other food spoiling gas altogether, so as to preserve freshness of the fruits for an extended period of time.

As illustrated in FIGS. 2C and 2D, the food preserving device 13 is consisted of a honeycomb filter 14′ or a teabag pouch 14″, a casing for encapsulating the honeycombed substrate 14′, and attaching means configured as a suction cup 133. The casing consists of a first porous casing portion 131, and a second porous casing portion 132 removably engaged with the first casing portion 131 to form a receiving chamber for fully accommodating the honeycomb filter 14′ or teabag pouch 14″.

More specifically, instead of incorporating and using the membrane 14 as shown in FIG. 2B, the honeycomb filter 14′ as shown in FIG. 2C, or the teabag pouch 14″ as shown in FIG. 2D can be alternatively incorporated and used by depositing a powdery material, such as activated carbon, therein to absorb moisture, oxygen and remove other odors. For the honeycomb filter 14′, the powdery material is embedded or molded thereon. For the teabag pouch 14″, the powdery material is encased therein. With the combination of the activated carbon particles and other gas absorbents for absorption of the food spoiling gas, the honeycomb filter 14′ or the teabag pouch 14″ allows for absorption of moisture, oxygen, odors as well as ethylene and other food spoiling gas altogether, so as to preserve freshness of the fruits for an extended period of time.

The food container 10 is not specifically limited and can be any conventional packaging container for foods, such as carton box, wooden crate, plastic case, and etc.

In use, the food preserving device 13 is pressed to get attached to the lower surface of the lid 12, and then the food container 10 with the food items is sealably closed by the lid 12. The pores formed through the first porous casing portion 131 and the second porous casing portion 132 allow gaseous exchange between the cavity of the food container and the nanoporous membrane 14 held inside the casing defined by the first and second casing portions 131, 132, such that the membrane 14 is capable of absorbing food spoiling gas contained in the cavity of the food container 10 and/or emitting from the food items, for example bananas, thereby to attain the effect of preserving freshness of the bananas.

In some cases, to maintain a desirable moisture level within the food container, the food container may comprise a plurality of air vents formed on the lid or upper walls of the food container to allow for air circulation.

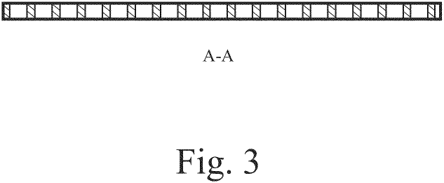

As a variation of the food preserving device 13 as shown in FIG. 2A, the food preserving device of FIG. 3 shows two attaching elements in the form of suction cups 133 are provided in spaced apart fashion on top of the first porous casing portion 131. Except for this, the food preserving device 13 is substantially same as in structure the one described above.

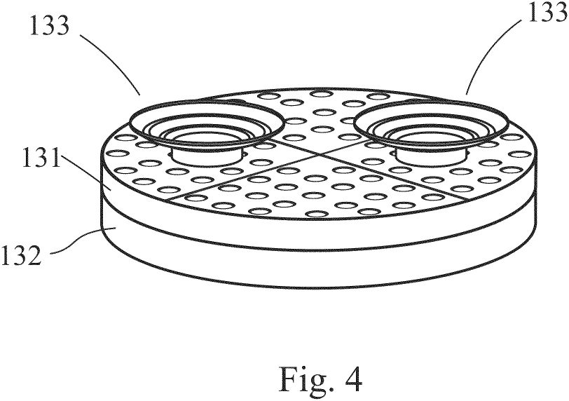

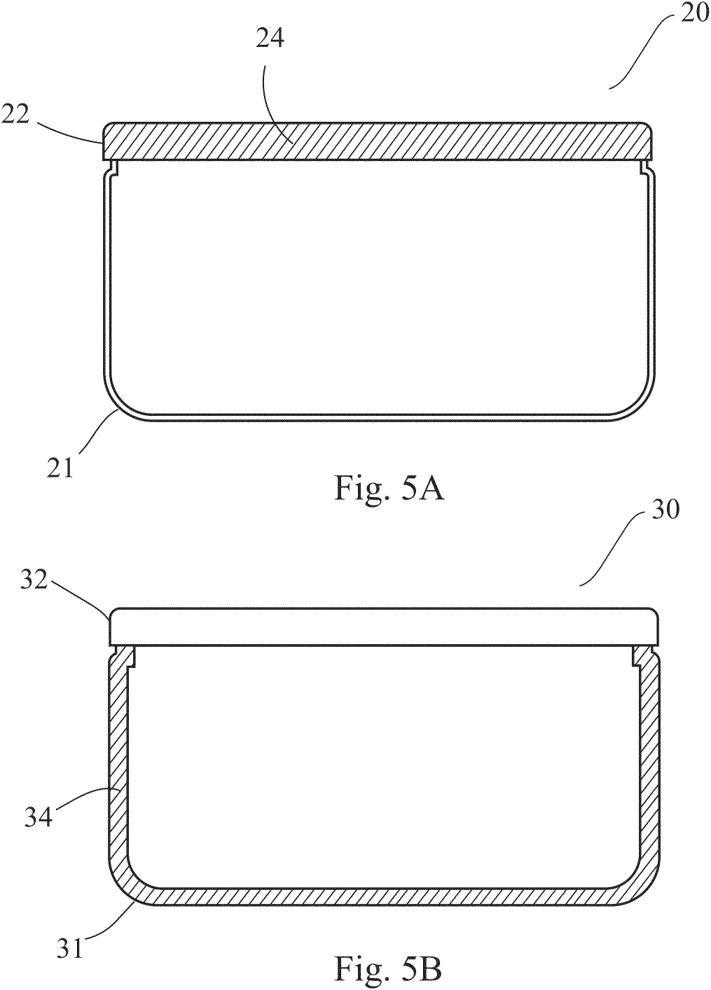

Shown in FIG. 4A is a second embodiment of the food container 20 of the present invention comprising a container body 21 and a lid 22. In this embodiment, the food preserving element is admixed or blended with the material of the container lid 22, and the admixture or blend 24 is then used to mold the lid 22. Specifically, the food preserving element is selected from at least one gas absorbent capable of absorbing the food spoiling gas, the gas absorbent being added into a plastic material for making the lid 22.

The gas absorbent includes zeolite based substance, including but not limited to potassium-treated zeolite, silica including but not limited potassium permanganated silica. The plastic material for making the lid 22 includes any conventional polymer capable of thermal forming and molding, such as polyethylene terephthalate (PET), polyethylene (PE), polypropylene (PP), polystyrene (PS), polyvinyl chloride (PVC), polycarbonate (PC), acrylonitrile butadiene styrene (ABS), and monomers of di-methylterephthalate (DMT), 1,4-cyclohexanedimethanol (CHDM), and 2,2,4,4-tetramethyl-1,3-cyclobutanediol (TMCD) etc. Preferably, the plastic material is thermoplastics selected from the group consisting of polypropylene resin, and monomers of di-methylterephthalate (DMT), 1,4-cyclohexanedimethanol (CHDM), and 2,2,4,4-tetramethyl-1,3-cyclobutanediol (TMCD). The gas absorbent are admixed or blended with the polymer, and the admixture or blend is form or molded into the lid of the container.

According to the invention, the gas absorbent is added in a ratio of about 0.5-10%, preferably about 1-5%, by weight of the plastic material.

Shown in FIG. 4B is a third embodiment of the food container 30 of the present invention comprising a container body 31 and a lid 32. Similar to the food container 20 described above, the food preserving element is admixed or blended with the material of the container body 32, and the admixture or blend 34 is then used to mold the body 31. The food preserving element is selected from at least one gas absorbent capable of absorbing the food spoiling gas, the gas absorbent being added into a plastic material for making the container body 31.

The gas absorbent and the plastic material used in the third embodiment shown in FIG. 4B and their ratio to form the admixture or blend may be made reference to those described in the second embodiment shown in FIG. 4A, and are not elaborated herein.

Similar to the food container 10 discussed in the first embodiment of the invention above, one or more further gas absorbents for absorption of the food spoiling gases may be added into the plastic material useful for making the container lid or the container body to make or mold the container lid or the container body. The further gas absorbents includes particles of activated carbon and other gas absorbents for absorption of moisture, bad smells and other food spoiling gas altogether.

Advantageously, the food containers 20, 30 comprising the food preserving element of the second and the third embodiments may be subjected to a heating treatment for removal of the food spoiling gases including ethylene and water, so as to regenerate the material of the food container. The regenerated food container may be re-used repeatedly.

While the present invention is described in connection with what is presently considered to be the most practical and preferred embodiment, it should be appreciated that the invention is not limited to the disclosed embodiment, and is intended to cover various modifications and equivalent arrangements included within the spirit and scope of the claims. Modifications and variations in the present invention may be made without departing from the novel aspects of the invention as defined in the claims, and this application is limited only by the scope of the claims.

1. A food container for preserving freshness of food, comprising:
a container body having a cavity adapted for containing food;
a lid detachably secured on the container body to close the cavity of the container; and
one or more food preserving elements capable of absorbing food spoiling gas to preserve freshness of food,
wherein the food preserving elements can be regenerated after absorbing food spoiling gas and are optionally configured to be releasably disposed inside the cavity of the food container and/or configured to be added into the material for preparing the food container.

2. The food container according to claim 1, the food preserving element is configured to releasably attached onto a lower surface of the lid or an inner surface of the cavity of the food container.

3. The food container according to claim 1, wherein the food preserving element is selected from at least one gas absorbent capable of absorbing food spoiling gas.

4. The food container according to claim 3, wherein the gas absorbent includes zeolite based substance including potassium-treated zeolite, activated carbon, silica including potassium permanganated silica, or any mixture thereof.

5. The food container according to claim 3, wherein the gas absorbent after absorbing food spoiling gas can be regenerated by a heating process.

6. The food container according to claim 1, wherein the food spoiling gas is at least one selected from the group consisting of ethylene, moisture, oxygen and any combination thereof.

7. The food container according to claim 3, wherein the food preserving element is provided in a form of a membrane comprising a membrane substrate and the gas absorbent disposed on or into the membrane substrate.

8. The food container according to claim 7, wherein the membrane substrate comprises a nanoporous material and the gas absorbent is applied on and/or into the material.

9. The food container according to claim 8, wherein the nanoporous material is a fabric or an activated carbon cloth.

10. The food container according to claim 8, wherein the gas absorbent is applied by an adhesive resin to be dispersed or coated on the nanoporous material.

11. The food container according to claim 10, wherein the adhesive resin is a silicone binder.

12. The food container according to claim 3, wherein the food preserving element is provided in a form of a honeycomb structure comprising the gas absorbent or coated with the gas absorbent thereon.

13. The food container according to claim 3, wherein the food preserving element is provided in a form of a teabag pouch encasing the gas absorbent.

14. The food container according to claim 7, wherein the membrane or the honeycomb structure or the teabag pouch is removably encapsulated in a casing comprising a first porous casing portion and a second porous casing portion removably engageable with the first casing portion to form the casing.

15. The food container according to claim 14, wherein the casing further comprises one or more attaching elements for releasably attaching onto the lower surface of the lid or the inner surface of the cavity of the food container.

16. The food container according to claim 15, wherein the attaching element is selected from the group consisting of suction cup, self-adhesive and magnet, hook and bar fastener, and hook and loop fastener.

17. The food container according to claim 14, wherein the casing comprises the gas absorbent or is coated with the gas absorbent thereon.

18. The food container according to claim 3, wherein the gas absorbent is added into the plastic material in a ratio of about 0.5-10% by weight of the plastic material.

19. The food container according to claim 18, wherein the gas absorbent is added in a ratio of about 1-5%, by weight of the plastic material.

20. The food container according to claim 19, wherein the plastic material is thermoplastics selected from the group consisting of polypropylene resin, and monomers of di-methylterephthalate (DMT), 1,4-cyclohexanedimethanol (CHDM), and 2,2,4,4-tetramethyl-1,3-cyclobutanediol (TMCD).

21. The food container according to claim 12, wherein the membrane or the honeycomb structure or the teabag pouch is removably encapsulated in a casing comprising a first porous casing portion and a second porous casing portion removably engageable with the first casing portion to form the casing.

22. The food container according to claim 13, wherein the membrane or the honeycomb structure or the teabag pouch is removably encapsulated in a casing comprising a first porous casing portion and a second porous casing portion removably engageable with the first casing portion to form the casing.
